(19) United States
(12) Patent Application Publication
(10) Pub. No.: US 2013/0179238 A1
(43) Pub. Date: Jul. 11, 2013

(54) METHODS AND APPARATUS FOR PROVIDING ACCESS CONTROLLED PARKING

(71) Applicants: FREDERICK Maltby WARNER, IV, Marine City, MI (US); Bryan W. Baker, Mill Valley, CA (US)

(72) Inventors: FREDERICK Maltby WARNER, IV, Marine City, MI (US); Bryan W. Baker, Mill Valley, CA (US)

(21) Appl. No.: 13/423,104

(22) Filed: Mar. 16, 2012

Related U.S. Application Data
(60) Provisional application No. 61/453,445, filed on Mar. 16, 2011.

(51) Int. Cl. G07B 15/00

(52) U.S. Cl. CPC G07B 15/00
USPC 705/13; 340/5.61

(57) ABSTRACT

Methods, apparatus, and systems are provided for an access controlled parking system. The invention includes a parking access system with a public parking location having controlled access; a garage door opener transmitter adapted to generate at least one unique signal; a receiver operable to receive the unique signal from the garage door opener transmitter; a processor coupled to the receiver and operable to grant or deny access to the public parking location based on the unique signal and to communicate receipt of the unique signal from the garage door opener transmitter to a central system; and a database system within the central system operable to associate the unique signal with an account for payment for use of the parking location. Numerous additional aspects are disclosed.

### CROSS-REFERENCE TO RELATED APPLICATIONS

The present application claims priority to U.S. Provisional Application No. 61/453,445 filed Mar. 16, 2011 and entitled “Methods and Apparatus for Providing Access Controlled Parking” by Frederick M. Warner, IV, which is hereby incorporated herein by reference for all purposes.

### FIELD OF THE INVENTION

The present invention generally relates to controlled access parking systems, and more particularly to payment for and control of access to parking spaces using a personal garage door opener (GDO).

### BACKGROUND OF THE INVENTION

Conventional parking garages typically issue parking access tickets to drivers as the drivers enter the parking facility and then employ several cashiers to manually collect payment upon the drivers' exit. If a parking access ticket is lost, drivers are typically charged for a full period of parking even if the driver's vehicle was in the garage for only a short time. If a driver does not have funds or a credit card with them, it can be difficult and expensive to collect payment. Smaller parking facilities with limited parking locations may have a difficult time competing with larger facilities with many locations. Drivers who frequently use parking facilities and who may be looking for discount parking may find very limited options since competing facilities typically do not participate in any kind of universal discount program. Thus, what is needed is a controlled access parking system that overcomes the above limitations and problems.

### SUMMARY OF THE INVENTION

The embodiments of the present invention generally relate to methods and apparatus for implementing a parking access control and payment system using personal garage door openers (GDO). In some embodiments, the present invention provides a parking access system with a public parking location having controlled access; a garage door opener transmitter adapted to generate at least one unique signal; a receiver operable to receive the unique signal from the garage door opener transmitter; a processor coupled to the receiver and operable to grant or deny access to the public parking location based on the unique signal and to communicate receipt of the unique signal from the garage door opener transmitter to a central system; and a database system within the central system operable to associate the unique signal with an account for payment for use of the parking location.

In other embodiments, the invention provides an access control parking system. The system includes a public parking area having controlled access; a garage door opener transmitter adapted to generate at least one unique signal; a receiver operable to receive the unique signal from the garage door opener transmitter; a processor coupled to the receiver and operable to grant or deny access to the public parking area based on the unique signal and to communicate receipt of the unique signal from the garage door opener transmitter to a parking control system; and a database system within the parking control system operable to be used to associate the unique signal with an account for payment for use of the public parking area.

In yet other embodiments, the invention provides a base station adapted for use in an access control parking system. The base station includes a receiver operable to receive a unique signal from a garage door opener transmitter adapted to generate at least one unique signal; a processor coupled to the receiver and operable to grant or deny access to a public parking area based on the unique signal; and a transmitter coupled to the processor and adapted to be used by the processor to communicate receipt of the unique signal from the garage door opener transmitter to a parking control system.

In still yet other embodiments, the invention provides a method of operating an access control parking system. The method includes receiving a unique signal from a garage door opener transmitter; allowing entry to a parking area based on receipt of the unique signal; determining if the unique signal is associated with a user registered with the access control parking system; and charging a financial account associated with the user upon departure from the parking area.

These and other features and aspects of the present invention will become more fully apparent from the following detailed description of exemplary embodiments, the appended claims and the accompanying drawings.

### BRIEF DESCRIPTION OF THE DRAWINGS

An artisan of ordinary skill will understand that the drawings, described below, are for illustration purposes only. The drawings are not intended to limit the scope of the present teachings in any way.

FIG. 1 is a schematic illustration of a user vehicle entering an example access control parking system 100 according to embodiments of the present invention.

FIG. 2 is a schematic illustration of a user vehicle entering an example access control parking system 100 according to embodiments of the present invention.

FIG. 3 is a schematic illustration of an example garage door opener transmitter adapted for use with the example access control parking system of FIGS. 1 and 2 according to embodiments of the present invention.

FIG. 4 is an illustration of an example database that may be stored in a database system of a parking control system according to embodiments of the present invention.

FIGS. 5A and 5B are a flowchart depicting a first example method of operating the example access control parking system of FIGS. 1 and 2 according to embodiments of the present invention.

FIG. 6 is a flowchart depicting a second example method of operating the example access control parking system of FIGS. 1 and 2 according to embodiments of the present invention.

### DETAILED DESCRIPTION

For the purpose of interpreting this specification, whenever appropriate, terms used in the singular will also include the plural and vice versa. The use of “or” is intended to mean “and/or” unless stated otherwise. The use of “a” herein is intended to mean “one or more” unless stated otherwise or where the use of “one or more” is clearly inappropriate. The use of “comprise,” “comprises,” “comprising,” “include,” “includes,” and “including” are interchangeable and not intended to be limiting. Furthermore, where the description of one or more embodiments uses the term “comprising,” those of ordinary skill in the art would understand that, in some specific instances, the embodiment or embodiments can be alternatively described using the language “consisting essentially of” and/or “consisting of.”

While the present teachings are described in conjunction with various embodiments, it is not intended that the present teachings be limited to such embodiments. On the contrary, the present teachings encompass various alternatives, modifications, and equivalents, as will be appreciated by those of ordinary skill in the art.

The present invention provides a parking access and control system with a public parking area having controlled access. The invention includes a garage door opener transmitter adapted to generate at least one unique signal; a receiver operable to receive the unique signal from the garage door opener transmitter; a processor coupled to the receiver and operable to grant or deny access to the public parking area based on the unique signal and to communicate receipt of the unique signal from the garage door opener transmitter to a parking control system; and a database system within the parking control system operable to associate the unique signal with an account for payment for use of the public parking area.

Residential garage door openers are commonly used in households across the country. Typically, a residential or commercial garage door opener (GDO) includes a vehicle mounted GDO transmitter that is operable to generate a unique code that the GDO recognizes and responds to by opening or closing the garage door. Many GDO transmitters operate at approximately a 390 MHz frequency, though other frequencies may be used, and they may also be able to transmit on three or more different channels to allow control of multiple doors or other devices.

Many GDOs use a security protocol (e.g., “Security+®”) that involves a “rolling” or “hoping” code which changes with each use. Once a GDO and transmitter are synchronized, each time a code is transmitted by the GDO transmitter and received by the GDO, a new code is generated and stored by identical “pseudo” random number generators in both the GDO and in the transmitter. The two random number generators thus remain synchronized and since they are identical, they generate the same new code for the next use. The codes may include forty or more bits and thus may have more than a trillion unique possibilities. To remain synchronized, the GDO may respond to codes that match any of the next two or three hundred codes that will be generated which still allows for more than 100 billion unique possibilities. In addition to GDO transmitters, automobile remote entry key transmitters may also work in a similar manner. Likewise, a cell phone or other wireless device may be programmed to generate and store similar codes.

In addition to the security codes, GDO transmitters may also include radio frequency identification (RFID) transmitters and/or other wireless transmitters/receivers (e.g., near field identification (NFID) transmitters, Bluetooth® transmitters, etc.)

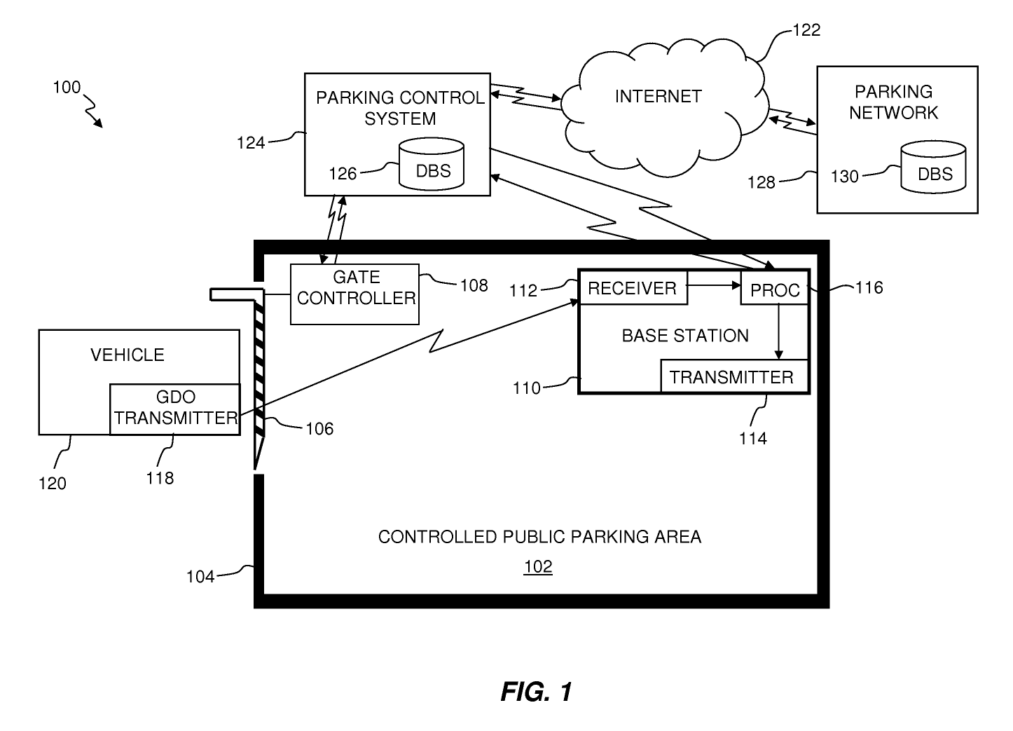

Turning now to FIG. 1, a schematic representation of an access control parking system 100 is depicted. The access control parking system 100 includes a controlled public parking area 102 that is surrounded by an enclosure 104 or any other means of restricting vehicle access to the controlled public parking area 102 so that only authorized vehicles may enter the controlled public parking area 102. For example, the controlled public parking area 102 may be a public parking garage, a fenced lot, a roadway with limited access, etc. The controlled public parking area 102 includes at least one gate 106 that is controlled by a gate controller 108. In some embodiments, the controlled public parking area 102 may include a plurality of gates 106. Each gate 106 may be centrally controlled by a single gate controller 108 or each gate 106 may have its own gate controller 108. The gate 106 may include an information display and means to issue a parking access ticket.

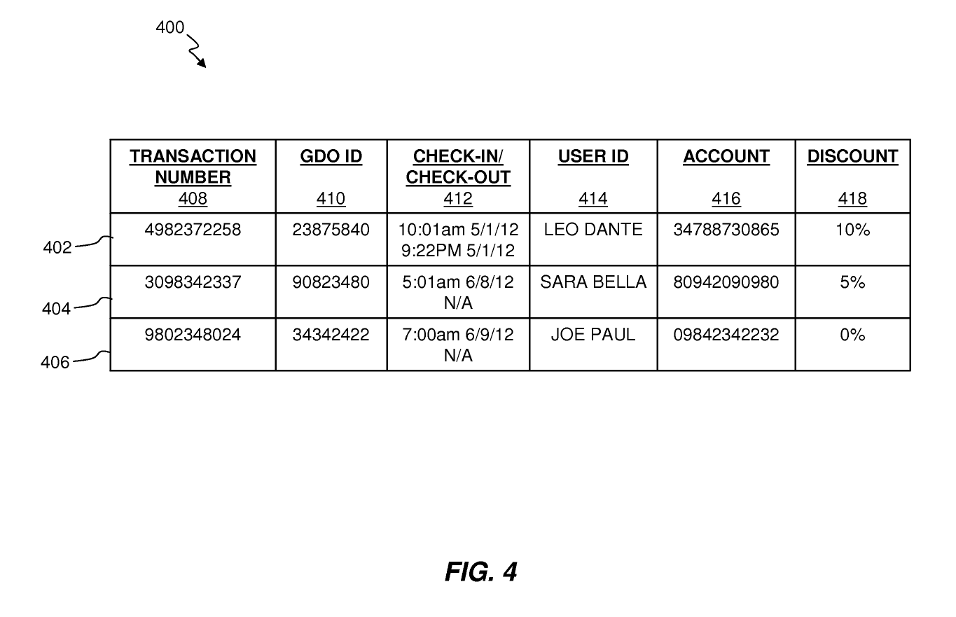

The controlled public parking area 102 includes at least one base station 110. The base station 110 may include a receiver 112, a transmitter 114, and a processor 116 coupled to the receiver 112 and the transmitter 114. The receiver 112 is adapted to receive signals from a GDO transmitter 118 mounted in or built into a vehicle 120 to be parked in the controlled public parking area 102. The GDO transmitter 118 is adapted to generate and transmit a unique signal representative of a unique identifier that the system 100 can use to associate vehicles 120 to be parked with users or customers of the system 100. The base station 110 is adapted to communicate either directly or indirectly via the Internet 122 with a parking control system 124 (PCS 124). The PCS 124 may be implemented in software adapted to be executed on one or more general-purpose computers. The PCS 124 may include one or more database systems 126 adapted to store information about users of the system including user accounts, vehicles, affiliations, activity, etc. An example database that may be employed by the database systems 126 is described in more detail below with respect to FIG. 4. In addition to the PCS 124, the access control parking system 100 may also include a parking network 128 which may be implemented in software adapted to be executed on one or more networked general-purpose computers. The parking network 128 may also include one or more database systems 130 adapted to store information about users of the system including user accounts, vehicles, affiliations, activity, etc.

In some embodiments, an automobile remote entry key transmitter may be used in place of a detachable/portable GDO transmitter. Likewise, in some embodiments, a programmed smart phone (e.g., Motorola® Droid®, Apple® iPhone®, RIM® Blackberry®, etc.), wireless device (e.g., Apple® iPad®, Nintendo® 3DS®, Sony® Playstation Vita®, etc.), or even a cell phone may be used in place of a GDO transmitter. In some embodiments, an onboard vehicle computer or a built-in (e.g., original manufacturer equipment) GDO transmitter may be used in place of a detachable/portable GDO transmitter. Likewise, in some embodiments a vehicle or personal navigation system (either built-in original manufacturer equipment or after-market equipment) or a portable navigation device (e.g., Garmin® nuvi®) may be used in place of a detachable/portable GDO transmitter.

In some embodiments, in place of a parking area 102 with controlled access, an enclosure 104, and a gate 106, an open parking area with a monitoring capability may be used. For example, an open parking lot with parking spaces equipped with sensors may be used. In some embodiments, a parking enforcement agent (e.g., a police officer) may be employed to verify the validity of parked vehicles' use of the open lot and ticket unauthorized vehicles parked in the open lot. In such embodiments, the base station 110 may be adapted to generate a list of authorized vehicles in the lot. In some embodiments, parking spaces may be assigned to specific vehicles and sensors or agents may be used to identify unauthorized vehicles for enforcement. Instead of using the GDO transmitter 118 to open a gate, the user uses the GDO transmitter 118 to communicate his vehicle's presence in the parking lot. A central payment station may issue a receipt and/or a parking access ticket in response to the base station 110 receiving the unique signal from the GDO transmitter 118.

In operation, when a user operating a vehicle 120 equipped with a GDO transmitter registered with the parking control system 124 of the present invention wants to park in a controlled public parking area 102 that is part of the access control parking system 100 of the present invention, the user approaches the gate 106. Upon pushing the button assigned for use with the access control parking system 100 on the GDO transmitter 119 (e.g., the public channel button), a signal from the GDO transmitter 119 is received by the base station 110. In some embodiments, the GDO transmitter 119 may include three or more buttons for broadcasting wireless signals on each of three or more channels (e.g., different frequencies). One of the channels may be assigned to transmit on a “public” channel used at any public parking location equipped with the access control parking system 100 of the present invention. The other channels may be used, for example, to control private GDOs at the residences of the users.

The GDO transmitter 119 may include a unique identifier so that when the “public channel” button is pressed, the GDO unique identifier is transmitted to the base station 110. Ultimately, the GDO unique identifier may be transmitted to the parking control system 124 to reference a customer identifier. The base station 110 receives the signal and assigns a unique transaction number. The GDO unique identifier and the unique transaction number (together, the transaction data) are sent to a processor 116 within the base station 110.

In some embodiments, the transaction data is sent from the processor to the centralized PCS 124. The PCS 124 records the transaction data and assigns a transaction identifier which may be used later by the PCS 124 to price the transaction. The GDO unique identifier and the unique transaction number may be sent to the PCS 124 via the Internet 122 or directly as shown in FIG. 1. The PCS 124 may use the transaction data to cross-reference the GDO to a customer identifier. The PCS 124 may then transmit a signal to the gate controller 108 to open the gate 106 and issue a ticket to the user. The ticket may include the transaction data and additional information such as, for example the current time and date. The PCS 124 may also create a parking event transaction identifier in the database system 126. The PCS transaction identifier may be sent to the parking network 128 for storage in the parking network database system 130 and also to the processor 116 in the base station 110. This information may be used later when the user checks out of the controlled parking area 102.

Once the gate 106 has been opened, the user is able to park his vehicle 120 in the controlled parking area 102. In some embodiments, while the vehicle 120 is parked, the parking network 128 may verify that the user has credit card account information or other payment means stored in the database system 130 of the parking network 128. In some embodiments, the parking network 128 may also determine if the user is associated with any kind of discount or promotion. For example, if the controlled parking area 102 is in a building of a law firm and the user is a member of the law firm, the user may be associated with a reduced parking rate in the database system 130 of the parking network 128. In some embodiments, a discount percentage may be sent, along with the PCS 124 transaction identifier, to the PCS 124 to be stored in the database system 126 for use later when the user checks out of the controlled parking area 102. The processor 116 in the base station 110 may also receive and store the transaction number, the GDO unique identifier associated with the transaction number, and a discount basis when applicable.

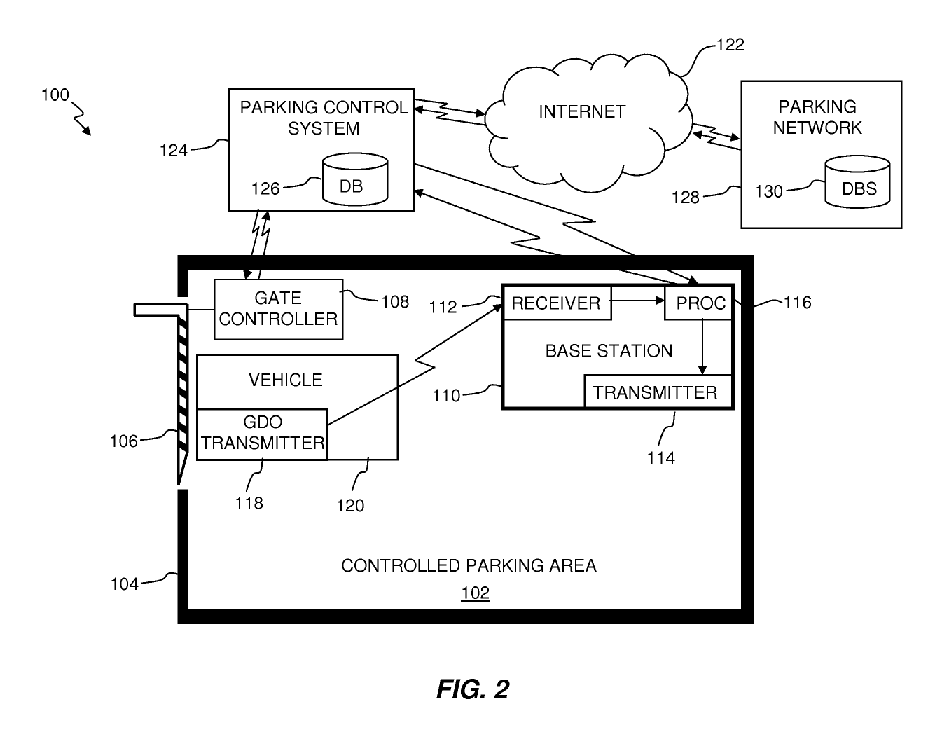

Turning to FIG. 2, when the user is ready to leave, he uses the GDO transmitter 118 again. The base station 110 reads the customer identifier, and recognizes that the user had a check in, but did not yet check out. Hence, the base station 110 determines that the user is leaving. The processor 116 in the base station 110 associates the GDO unique identifier with the PCS 124 transaction number, and sends the transaction number, a timestamp, and, if applicable, the discount basis to the PCS 124. The PCS 124 receives the transaction data with the time stamp, and calculates the amount due less the discount (if any). The PCS 124 may send information to the gate controller 108 to display the charge on the gate display, open the gate, and send the transaction to the parking network 128 for credit card (or other financial account) charge via the Internet 122. The transaction number along with the final charge maybe sent to the parking network 128 for final processing of the charge and stored in the parking network database system 130 to be recorded and formatted into an email receipt for the user. In some embodiments, the base station 110 may transmit a message to the GDO transmitter 118 that indicates the amount charged to the user's financial account.

In some embodiments, loyalty or frequent user points may be calculated according to rules defined within the system 100 and stored in a user record within the parking network database system 130 as a discount basis.

Note that the associations of the GDO unique identifier to a customer identifier and the transaction number to the PCS 124 may be done after the user has been granted entry to the controlled parking area. In other words, these remote database accesses may be performed after the user is allowed to park so that the user does not have to wait at the gate 106.

In some embodiments, the access control parking system 100 may be adapted to allow users without a GDO transmitter 118 to enter and exit the controlled parking area 102 using a conventional parking access ticket (e.g., with a encoded magnetic stripe) issued at the entrance gate.

Thus, the gate 106 can be opened without waiting for authorization to return to the user. Since the user may also be provided with a conventional parking access ticket, if the user's financial account cannot be charged via the PCS 124, the system 100 may issue a message (e.g., a text or email message) informing the user that updated financial account information is required and that the user will need to check out at a payment center, and not with the GDO transmitter 118, upon leaving.

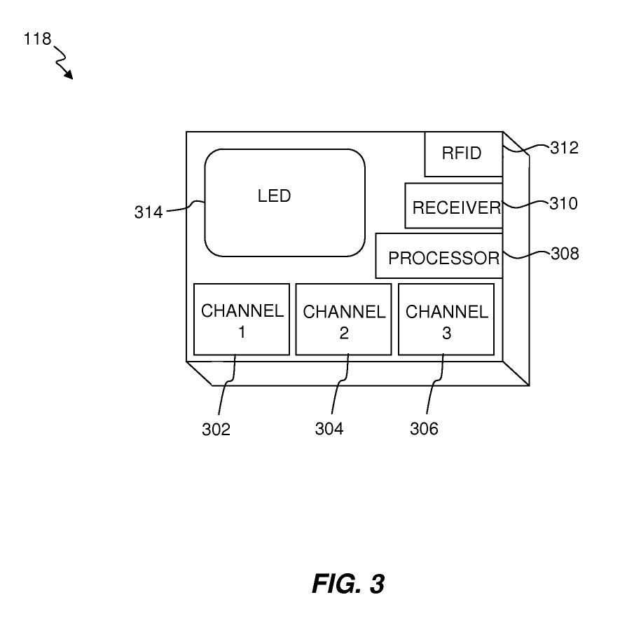

Turning to FIG. 3, a schematic illustration of an example GDO transmitter 118 adapted for use with the example access control parking system 100 of the present invention is shown. In some embodiments of the present invention, a conventional GDO transmitter may be used with the access control parking system 100. In some embodiments, a specially adapted GDO transmitter 118 may be used. For example, the GDO transmitter 118 may include three channel buttons 302, 304, 306 for activating transmission of a wireless signal. In some embodiments, the Channel 1 and Channel 2 buttons 302, 304 may activate transmission of GDO signals that are adapted to activate garage door openers. In some embodiments, the Channel 3 button may be used to activate transmission of the GDO unique identifier for access to public parking facilities using the access control parking system 100 of the present invention, as discussed above.

The GDO transmitter 118 of the present invention may also include a processor 308, a receiver 310, a radio frequency identification (RFID) circuit 312, and a light emitting diode (LED) display 314. In some embodiments, the RFID circuit 312 maybe used to provide and transmit the GDO unique identifier when the Channel 3 button is pressed. In some embodiments, the processor 308, the receiver 310, and the LED 314 may be used to receive and display messages transmitted from the base station 110. In some embodiments, the GDO transmitter 118 may include the ability to display parking rate and discount information, as well as, actual charge information upon completion of a transaction.

Turning to FIG. 4, an example database 400 for use in the database system 126 of the PCS 124 (and/or the database system 130 of the parking network 128) including three example records 402, 404, 406 is depicted. The example records 402, 404, 406 may each correspond to different parking events and although only three examples are shown, it will be understood that such a database 400 may include any number of entries or records. Likewise, the example database 400 only depicts a few example fields 408, 410, 412, 414, 416, 418 arranged in a simple flat table structure. It will be understood that any number of fields may be added or removed and that the database may be arranged in any practicable structure including multiple linked tables and relational elements. The example fields shown include a transaction number field 408, a GDO unique identifier field 410, a check-in/check-out time/date stamp field 412, a user identifier field 414, a user financial account information field 416, and a discount field 418.

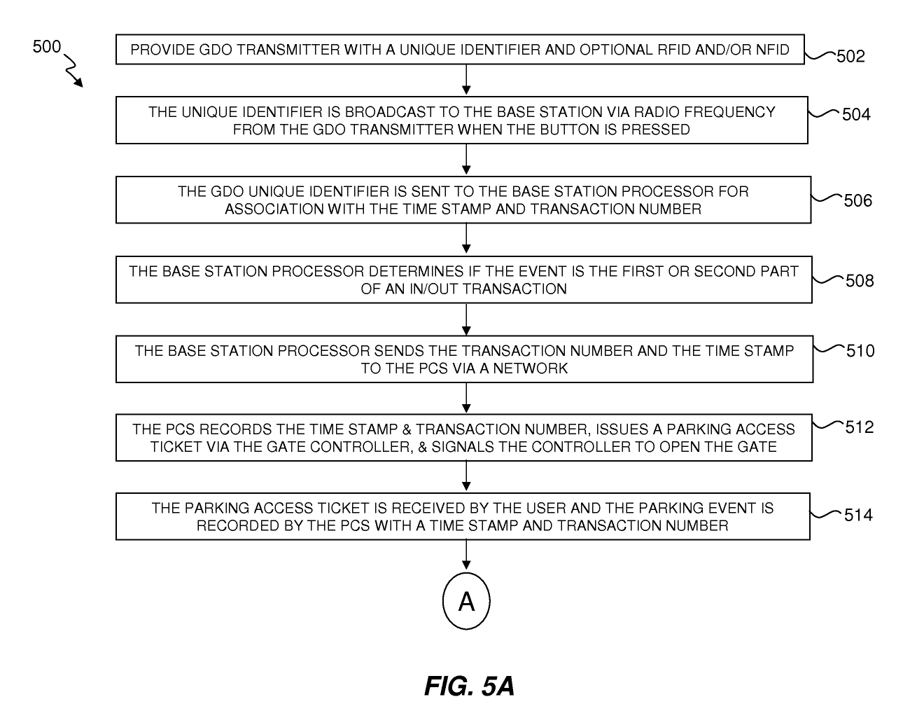

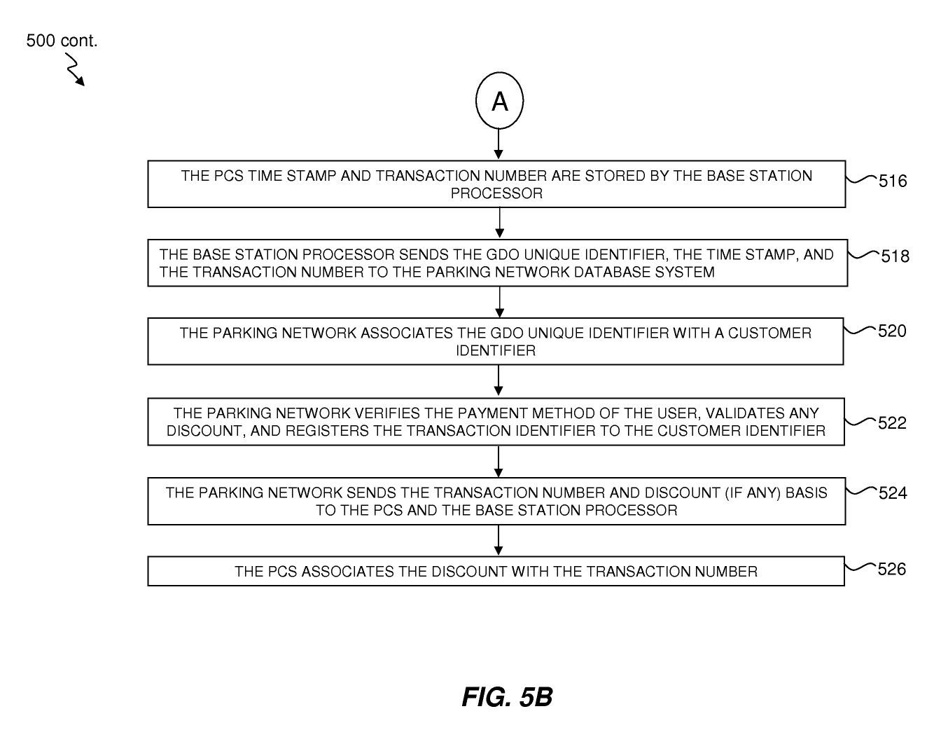

Turning now to FIGS. 5A and 5B, a first example method 500 of operating the example access control parking system 100 is illustrated in a flowchart. The example method 500 describes the steps taken when a user enters a controlled parking area. In step 502, a GDO transmitter with a unique identifier and optional RFID and/or NFID is provided. In step 504, the unique identifier is broadcast to the base station via radio frequency from the GDO transmitter when the button is pressed. In step 506, the GDO unique identifier is sent to the base station processor for association with the time stamp and transaction number. In step 508, the base station processor determines if the event is the first or second part of an in/out transaction. In Step 510, the base station processor sends the transaction number and the time stamp to the PCS via a network (e.g., Ethernet, IP wireless, etc.). In step 512, the PCS records the time stamp and the transaction number, issues a parking access ticket via the gate controller, and signals the gate controller to open the gate. In step 514, the parking access ticket is received by the user and the parking event is recorded by the PCS with a time stamp and transaction number. In step 516, the PCS time stamp and transaction number are stored by the base station processor. In step 518, the base station processor sends the GDO unique identifier, the time stamp, and the transaction number to the parking network database system. In step 520, the parking network associates the GDO unique identifier with a customer identifier. In step 522, the parking network verifies the payment method of the user, validates any discount, and registers the transaction identifier to the customer identifier. In step 524, the parking network sends the transaction number and discount (if any) basis to the PCS and the base station processor. In step 526, the PCS associates the discount with the transaction number.

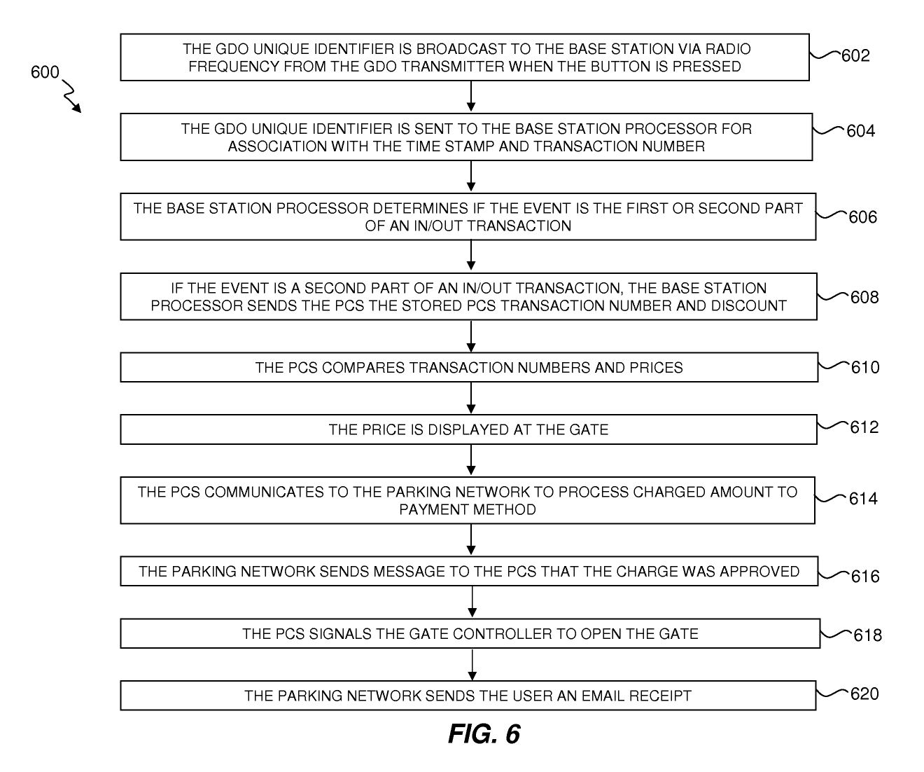

Turning now to FIG. 6, a second example method 600 of operating the example access control parking system 100 is illustrated in a flowchart. The example method 600 describes the steps taken when a user exits a controlled parking area. In step 602, the unique identifier is broadcast to the base station via radio frequency from the GDO transmitter when the button is pressed. In step 604, the GDO unique identifier is sent to the base station processor for association with the time stamp and transaction number. In step 606, the base station processor determines if the event is the first or second part of an in/out transaction. In step 608, if the event is a second part of an in/out transaction, the base station processor sends the PCS the stored PCS transaction number and discount. In step 610, the PCS compares transaction numbers and prices. In step 612, the price is displayed at the gate. In step 614, PCS communicates to the parking network to process charged amount to payment method. In step 616, parking network sends message to the PCS that the charge was approved. In step 618, the PCS signals the gate controller to open the gate. In step 620, the parking network sends the user an email receipt.

The embodiments of the teachings have been described in an illustrative manner. It is to be understood that the terminology, which has been used, is intended to be in the nature of words of description rather than of limitation. Many modifications and variations of the embodiments are possible in light of the above teachings. Therefore, within the scope of the appended claims, the embodiments can be practiced other than as specifically described.

The invention claimed is:

1. An access control parking system comprising:
a public parking area having controlled access;
a garage door opener transmitter adapted to generate at least one unique signal;
a receiver operable to receive the unique signal from the garage door opener transmitter;
a processor coupled to the receiver and operable to grant or deny access to the public parking area based on the unique signal and to communicate receipt of the unique signal from the garage door opener transmitter to a parking control system; and
a database system within the parking control system operable to be used to associate the unique signal with an account for payment for use of the public parking area.

2. The system of claim 1 wherein the controlled access includes a gate operable to be opened and closed by the parking control system.

3. The system of claim 1 wherein the garage door opener transmitter includes a button for activating the garage door opener transmitter to transmit a radio frequency identification number adapted to be used to uniquely identify a user to the parking control system.

4. The system of claim 1 wherein the parking control system includes a parking network and wherein the parking network includes a database system adapted to store information associated with a user of the access control parking system.

5. The system of claim 4 wherein the information associated with a user of the access control parking system includes financial account information and discount information.

6. The system of claim 1 wherein a user may use a wireless device or a smart phone to generate and transmit the unique signal to the receiver.

7. The system of claim 1 wherein the parking control system is operable to provide a parking access ticket to the user upon entry of the public parking area.

8. A base station adapted for use in an access control parking system, the base station comprising:
a receiver operable to receive a unique signal from a garage door opener transmitter adapted to generate at least one unique signal;
a processor coupled to the receiver and operable to grant or deny access to a public parking area based on the unique signal; and
a transmitter coupled to the processor and adapted to be used by the processor to communicate receipt of the unique signal from the garage door opener transmitter to a parking control system.

9. The base station of claim 8 wherein the processor is adapted to receive information regarding a user from the parking control system.

10. The base station of claim 8 wherein the base station is located at the public parking area with controlled access.

11. The base station of claim 10 wherein the processor is adapted to determine if a vehicle is entering or leaving the public parking area.

12. The base station of claim 11 wherein the processor is adapted to transmit a stored transaction number upon determining a user is departing from the public parking area.

13. The base station of claim 8 wherein the processor is adapted to associate the unique signal with a timestamp and a transaction number.

14. The base station of claim 8 wherein the receiver is operable to receive a unique signal associated with a user from a wireless device or a smart phone.

15. A method of operating an access control parking system, the method comprising:
receiving a unique signal from a garage door opener transmitter;
allowing entry to a parking area based on receipt of the unique signal;
determining if the unique signal is associated with a user registered with the access control parking system; and
charging a financial account associated with the user upon departure from the parking area.

16. The method of claim 15 further comprising associating the unique signal with a time stamp and a transaction number.

17. The method of claim 15 further comprising determining if the user is arriving at or departing from the parking area.

18. The method of claim 15 further comprising transmitting the time stamp and the transaction number to a parking control system.

19. The method of claim 15 further comprising accessing a database system to verify a payment method of the user before the user indicates the user is departing from the parking area.

20. The method of claim 15 further comprising associating a discount with a user's parking event.
